(19) United States
(12) Patent Application Publication
(10) Pub. No.: US 2017/0071153 A1
(43) Pub. Date: Mar. 16, 2017

(54) CLOG PREVENTING FEEDER ELEMENT

(71) Applicant: Thomas Leon Stanley, Alford, FL (US)

(72) Inventor: Thomas Leon Stanley, Alford, FL (US)

(21) Appl. No.: 15/089,692

(22) Filed: Apr. 4, 2016

Related U.S. Application Data
(60) Provisional application No. 62/218,110, filed on Sep. 14, 2015.

(51) Int. Cl. A01K 5/01; A01K 5/00; A01K 61/02; A01K 5/02

(52) U.S. Cl. CPC A01K 5/01; A01K 5/0225; A01K 5/004; A01K 61/02

(57) ABSTRACT

A feed tickler used in conjunction with either a round or square funnel feeder discharge opening. The tickler rotates with a feed dispersal disk of the feeder and agitates the feed to prevent clogging and choking of feed delivered through a dispersal end of the feeder funnel.

### CROSS-REFERENCE TO RELATED APPLICATION

This application claims the benefit of priority of U.S. provisional application No. 62/218,110, filed Sep. 14, 2015, the contents of which are herein incorporated by reference.

### BACKGROUND OF THE INVENTION

The present invention relates to feeders, and more particularly to feeders with a rotary dispersal unit for spreading feed for livestock, fish or game.

Feeders are a fairly ubiquitous device for dispersing food materials for livestock, fish, or game. While such feeders enjoy widespread popularity and use, they share a common problem in that the feed material gets clogged within the feeding chute or funnel, which prevents the feed from being dispersed on the ground, trough, or waters of a pond or lake.

As can be seen, there is a need for and improved feeder that prevents the clogging.

### SUMMARY OF THE INVENTION

In one aspect of the present invention, game feeder, includes: a hopper, adapted to receive a volume of feed; a distribution funnel disposed at a bottom end of said hopper, said funnel having an aperture at a bottom end thereof; a distribution plate positioned for rotation beneath said aperture, adapted for rotational dispersal of said feed; a coupler mounted for coaxial rotation with said distribution plate; and a tickler mounted at a first end for eccentric rotation with said coupler, said tickler having a length such that a second end of the tickler is positioned within said funnel aperture. The feeder may also include a rotary drive mechanism operatively attached to said coupler and adapted for axial rotation of said coupler. In some embodiments, the rotary drive mechanism is a motor. The motor may be contained within a motor housing disposed beneath the hopper.

In some embodiments, the coupler includes a receiving bore defined in a top end surface of the coupler, and has diameter that is larger than the diameter of the tickler. The coupler may also include a set bore defined in a side surface of the coupler and intersects the receiving bore. A set screw may be threadingly received within the set bore and is operable to urge the tickler against an opposed sidewall of the receiving bore.

In other embodiments, the coupler includes a receiving bore that is defined offset from a rotational axis of the coupler. The first end of the tickler is coupled within the receiving bore for eccentric rotation with the coupler.

In other aspects of the invention a feeder, includes: a hopper, adapted to receive a volume of feed; a distribution aperture is defined at a bottom of the hopper; a distribution plate is positioned for rotational movement beneath the distribution aperture; a coupler is mounted for coaxial rotation with the distribution plate; and a tickler is mounted at a first end for eccentric rotation with the coupler, the tickler having a length such that a second end of the tickler extends into said distribution aperture. In some embodiments of the feeder a distribution funnel is defined at a lower portion of the hopper. The feeder may also have a rotary drive mechanism operatively attached to the coupler and adapted to rotate the coupler. A motor may be operatively coupled to turn the rotary drive mechanism.

In yet other aspects of the invention, a feeder, includes a hopper, adapted to receive a volume of feed; a distribution aperture is defined at a bottom of the hopper and is adapted to disperse the volume of feed received within the hopper, a coupler is disposed for axial rotation beneath the distribution aperture; and a tickler having a first end operatively attached to the coupler for eccentric rotation with said coupler, the tickler having a length such that a second end of the tickler extends into said distribution aperture. In other embodiments, the feeder has a distribution funnel defined at a lower portion of the hopper, and the distribution aperture is defined at a bottom end of the distribution funnel. The feeder may also have a rotary drive mechanism operatively attached to and adapted to rotate the coupler. A motor may be operatively coupled to turn the rotary drive mechanism. In some embodiments, a receiving bore is defined in a top end surface of the coupler. The receiving bore has a diameter that is larger than the diameter of the tickler. In other embodiments, a set bore is defined in a side surface of the coupler and intersects the receiving bore; and a set screw is threadingly received within the set bore and is operable to urge the tickler against an opposed sidewall of the receiving bore. In other embodiments, the coupler includes a receiving bore defined offset from a rotational axis of the coupler, wherein the first end of the tickler is coupled within the receiving bore for eccentric rotation with the coupler.

These and other features, aspects and advantages of the present invention will become better understood with reference to the following drawings, description and claims.

### BRIEF DESCRIPTION OF THE DRAWINGS

FIG. 1 is a depiction of an embodiment of a game feeder.

FIG. 2 is a partial front elevation view of a dispenser and an embodiment of an agitator according to an embodiment of the present invention.

FIG. 3 is a partial front elevation view of a dispenser according to an embodiment of the present invention.

FIG. 4a is an overhead view of a coupler and tickler.

FIG. 4b is a detailed view of an embodiment of a receiving bore.

FIG. 5 is a side sectional view of an embodiment of a tickler received in a coupler along line 5-5 of FIG. 4a.

FIG. 6 is a side elevation view of an embodiment of an agitator attached to a coupler.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an agitator for ensuring the free flow of feed from the bin of a feeder. Feeders are utilized for the storage and dispersal of a food source for livestock, fish, and game. The food source, or feed, may be a specially selected feed for an animal which may come in a pelletized form. The food source may also include grains, such as corn, wheat, or seeds. The feed is contained within the feeder, which may be set to automatically distribute feed at a scheduled time, or may be manually activated to distribute feed.

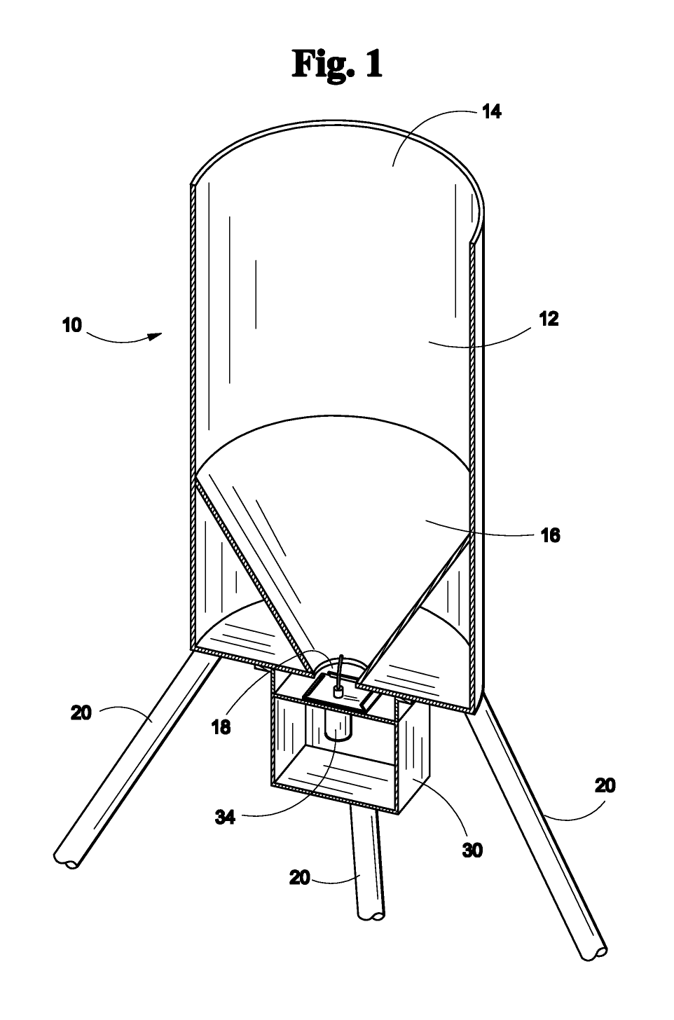

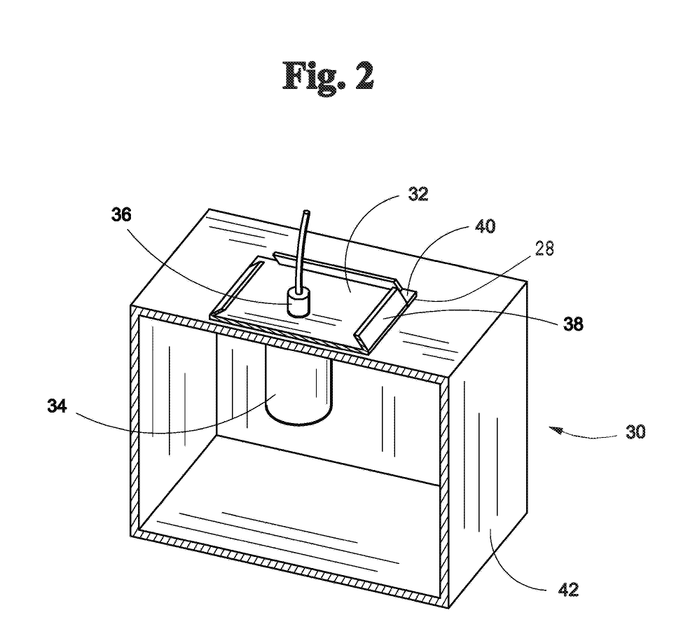

As best seen in reference to FIGS. 1 and 2, a typical embodiment of feeder 10 is depicted. The feeder 10 comprises a hopper 12 that contains a volume of feed. The upper end of the hopper 12 may be provided with an opening 14 through which feed may be added to replenish the hopper 12 as the feed is dispersed to provide nourishment for the intended animal. The bottom end may include a funnel portion 16, which channels the feed contained within the hopper 12 towards an opening, or discharge aperture 18 through which the feed may selectively exit the hopper 12 for dispersal. In the embodiment shown, the hopper 12 is cylindrical and the funnel portion 16 is a conic cylinder, though other shapes will work with the present invention with equally satisfying results.

The feeder 10 may be supported on a tripod mount 20, such as that depicted in the drawings. Alternatively, the feeder 10 may be mounted to a vertical structure, such as a pole, a wall, or a tree, such as by straps, bands, bolts, or other suitable fasteners.

A feed dispersal unit 30 is provided beneath the aperture 18 of the hopper 12. The dispersal unit 30, may include a disk or plate 32, mounted beneath the aperture 18. In preferred embodiments, the plate 18 is secured to a motor 34 or other rotating mechanism via a coupler 36, so that the motor 34 may rotate the disk or plate 32 beneath the aperture 18 such that feed material falling from the hopper 12 lands on the disk 32, and is slung outwardly as the disk 32 rotates. The plate 32 may further include upturned side edges 38, with a plurality of openings 40 in the side edges 28 through which the feed may be dispersed in a generally radial pattern. The motor 34 may be contained within a housing 42, so as to protect it from the elements or disturbance by the livestock or game animals that may frequent the feeder 10. As will be appreciated, feed may get compacted, or otherwise restricted, at the aperture 18 such that it is no longer able to fall onto the disk 32 for dispersal.

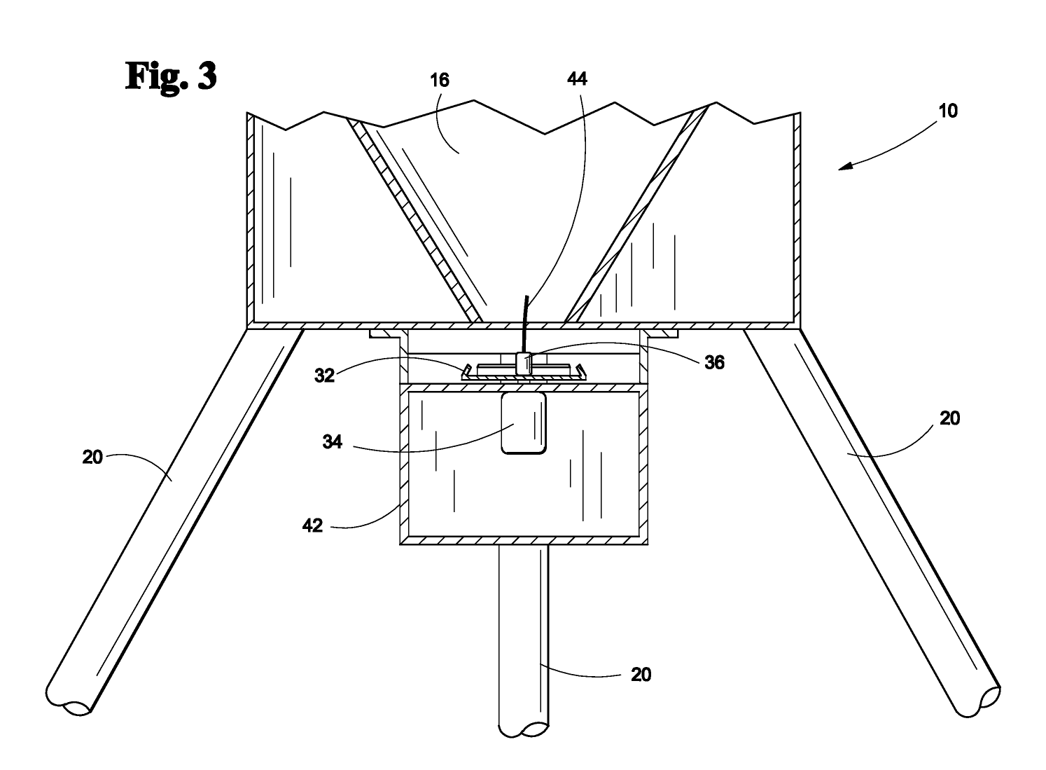

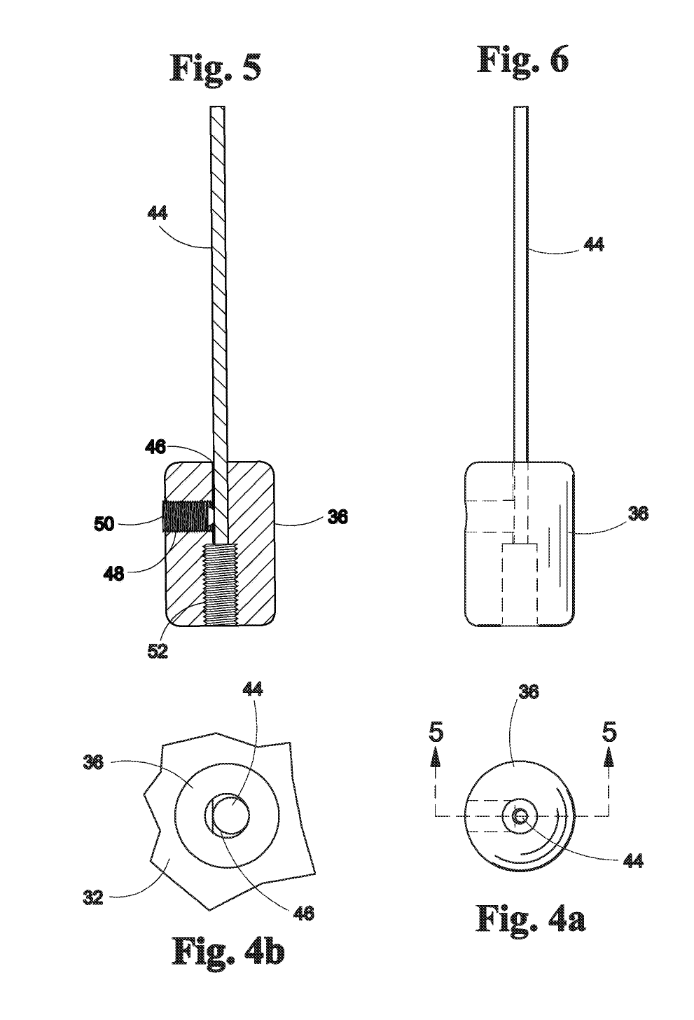

As seen in reference to FIGS. 4-6, according to an embodiment of the present invention, the coupler 36 securing the disk 32 to the motor 34 axel is adapted to receive a rod, or tickler 44. The coupler 36 of a conventional feeder 10 may be adapted to receive the tickler 44 in an eccentric location from the axis of rotation of the coupler 36. The tickler 44 comprises an elongate rod or shaft 44 having a first end and a second end.

According to a preferred embodiment of the invention, a receiving bore 46 may be defined in an upper surface of the coupler 36 coaxial with the rotational axis of the motor 34 and coupler 36. The receiving bore 46 is defined to be slightly larger than the diameter of tickler 44 at a first end, which is received in the receiving bore 46. The coupler 36 is adapted with a second, set bore 48 that intersects with the receiving bore 46. Preferably the set bore 48 is defined through a lateral surface of the coupler 36, and is threaded so as to receive a set screw 50. As the set screw 50 is tightened, the first end of the tickler 44 is urged against the opposing sidewall of the receiving bore 46. By this arrangement, the tickler 44 is mounted in an eccentric relation with the axis of rotation of the coupler 36, and motor 34 shaft.

The tickler 44 has a length that is selected to extend at least into the hopper's aperture 18. In certain preferred embodiments, the tickler 44 may have a length of approximately 1-4 inches, depending upon the spatial relation of the coupler 36 and the aperture 18.

In a preferred embodiment of the invention, the coupler 36 may be fabricated utilizing a ¾ inch length 5/16 to ½ inch brass rod, or other suitable material, that is drilled and tapped at one end to accept a threaded shaft, such as a 10-32 piece of thread stock, to re-secure the coupler 36 and distribution disk 32 to the shaft of the motor 34. The balance of the ½ inch rod is drilled to 5/32 inch for accepting an approximately 0.0625 to 0.125 inch rod with a length approximately 2 ⅜ inches to 4 inches long. This rod 44 may be cut to change length if necessary. As will be realized, the coupling 36, rod length or rod diameter can vary, based on the configuration of the feeder distribution elements.

As the motor 34 is activated to turn the dispersing disk 32, the tickler rod 44 rotates within the aperture 18 to disturb the feed and prevent the feed from becoming compacted or otherwise obstruct the aperture 18. As will be appreciated, the motor 34 may be activated with a timer, or manually, via a switch, located at the device, or it may be controlled remotely via a wireless connection.

According to other embodiments of the invention, the receiving bore 46 may be defined in an offset position from the center axis of the coupler 36 so that the tickler 44 may still operate in an eccentric manner within the discharge aperture 18. However, if the tickler 44 is positioned too far off from the axis of rotation, the rod 44 may encounter excessive resistance by unnecessarily stirring the feed, rather than simply tickling the feed within a narrow portion of the discharge aperture 18. This can lead to premature wear of the motor 34, and related unsatisfactory consequences. It should be understood, of course, that the foregoing relates to exemplary embodiments of the invention and that modifications may be made without departing from the spirit and scope of the invention as set forth in the following claims.

What is claimed is:

1. A feeder, comprising:
a hopper, adapted to receive a volume of feed;
a distribution funnel disposed at a bottom end of said hopper, said funnel having an aperture at a bottom end thereof;
a distribution plate positioned for rotation beneath said aperture, adapted for rotational dispersal of said feed;
a coupler mounted for coaxial rotation with said distribution plate; and
a tickler mounted at a first end for eccentric rotation with said coupler, said tickler having a length such that a second end of the tickler is positioned within said funnel aperture.

2. The feeder of claim 1, further comprising:
a rotary drive mechanism operatively attached to said coupler and adapted for axial rotation of said coupler.

3. The feeder of claim 2, wherein the rotary drive mechanism comprises a motor.

4. The feeder of claim 3, further comprising:
a motor housing disposed beneath the hopper, wherein the motor is contained within the motor housing.

5. The feeder of claim 2, wherein the coupler further comprises:
a receiving bore defined in a top end surface of the coupler, the receiving bore having a diameter that is larger than the diameter of the tickler.

6. The feeder of claim 5, further comprising:
a set bore defined in a side surface of the coupler and intersecting the receiving bore.

7. The feeder of claim 6, further comprising:
a set screw threadingly received within the set bore and operable to urge the tickler against an opposed sidewall of the receiving bore.

8. The feeder of claim 2, wherein the coupler further comprises:
a receiving bore defined offset from a rotational axis of the coupler.

9. The feeder of claim 8, wherein the first end of the tickler is coupled within the receiving bore for eccentric rotation with the coupler.

10. A feeder, comprising:
a hopper, adapted to receive a volume of feed;
a distribution aperture defined at a bottom of the hopper;
a distribution plate positioned for rotational movement beneath said distribution aperture;
a coupler mounted for coaxial rotation with said distribution plate; and
a tickler mounted at a first end for eccentric rotation with said coupler, said tickler having a length such that a second end of the tickler extends into said distribution aperture.

11. The feeder of claim 10, further comprising:
a distribution funnel defined at a lower portion of the hopper.

12. The feeder of claim 10, further comprising:
a rotary drive mechanism operatively attached to the coupler and adapted to rotate the coupler.

13. The feeder of claim 12, further comprising:
a motor operatively coupled to turn the rotary drive mechanism.

14. A feeder, comprising:
a hopper, adapted to receive a volume of feed;
a distribution aperture defined at a bottom of the hopper, adapted to selectively disperse the volume of feed received within the hopper;
a coupler disposed for axial rotation beneath the distribution aperture; and
a tickler having a first end operatively attached to the coupler for eccentric rotation with said coupler, said tickler having a length such that a second end of the tickler extends into said distribution aperture.

15. The feeder of claim 14, further comprising:
a distribution funnel defined at a lower portion of the hopper, wherein the distribution aperture is defined at a bottom end of the distribution funnel.

16. The feeder of claim 14, further comprising:
a rotary drive mechanism operatively attached to the coupler and adapted to rotate the coupler.

17. The feeder of claim 16, further comprising:
a motor operatively coupled to turn the rotary drive mechanism.

18. The feeder of claim 14, wherein the coupler further comprises:
a receiving bore defined in a top end surface of the coupler, the receiving bore having a diameter that is larger than the diameter of the tickler.

19. The feeder of claim 18, further comprising:
a set bore defined in a side surface of the coupler and intersecting the receiving bore; and
a set screw threadingly received within the set bore and operable to urge the tickler against an opposed sidewall of the receiving bore.

20. The feeder of claim 14, wherein the coupler further comprises:
a receiving bore defined offset from a rotational axis of the coupler, wherein the first end of the tickler is coupled within the receiving bore for eccentric rotation with the coupler.
